(19) United States
(12) Patent Application Publication
(10) Pub. No.: US 2026/0142372 A1
(43) Pub. Date: May 21, 2026

(54) TUNING CIRCUIT ARCHITECTURE TO INCREASE METASURFACE ANTENNA PERFORMANCE

(71) Applicant: Kymeta Corporation, Redmond, WA (US)

(72) Inventors: Mohammad Mahdi Honari Kalateh, Redmond, WA (US); Seyed Mohamad Amin Momeni Hasan Abadi, Redmond, WA (US)

(21) Appl. No.: 19/389,753

(22) Filed: Nov. 14, 2025

Related U.S. Application Data
(60) Provisional application No. 63/722,948, filed on Nov. 20, 2024.

(51) Int. Cl. H01Q 3/46

(52) U.S. Cl. CPC H01Q 3/46

(57) ABSTRACT

An antenna having a tuning circuit architecture and methods for using the same are described. In some embodiments, an antenna includes a metasurface having a plurality of radio-frequency (RF) radiating antenna elements. Each of the plurality of antenna elements includes a tuning circuit including a voltage-variable capacitor, a first fixed capacitor coupled in series with the voltage-variable capacitor, and a second fixed capacitor coupled in parallel with the voltage-variable capacitor.

### RELATED APPLICATION

The present application is a non-provisional application of and claims the benefit of U.S. Provisional Patent Application No. 63/722,948, filed Nov. 20, 2024, and entitled “TUNING CIRCUIT ARCHITECTURE TO INCREASE METASURFACE ANTENNA PERFORMANCE”, which is incorporated by reference in its entirety.

### FIELD OF THE DISCLOSURE

Embodiments disclosed herein are related generally to wireless communication; in particular, embodiments disclosed herein are related to tuning circuits for electronically scanned array antennas, for example, a metasurface-based electronically scanned array.

### BACKGROUND

Metasurface antennas have recently emerged as a new flat-panel antenna technology for generating steered, directive beams from a lightweight, low-cost, and planar physical platform. Such metasurface antennas have been recently used in a number of applications, such as, for example, satellite communication.

Metasurface antennas may comprise radio-frequency (RF) radiating metamaterial antenna elements that can selectively couple energy from a feed wave to produce beams that may be controlled for use in communication. These antennas are capable of achieving comparable performance to phased array antennas from an inexpensive and easy-to-manufacture hardware platform.

In a metasurface having RF radiating metamaterial antenna elements, one performance parameter of a RF antenna element design is the RF frequency range over which the resonance of the RF element can be tuned. The tuning of the resonance frequency of the RF element of a metamaterial of an antenna can be enabled by changing the capacitance of the RF element.

### SUMMARY

An antenna having a tuning circuit architecture and methods for using the same are described. In some embodiments, an antenna includes a metasurface having a plurality of radio-frequency (RF) radiating antenna elements. Each of the plurality of antenna elements includes a tuning circuit including a voltage-variable capacitor, a first fixed capacitor coupled in series with the voltage-variable capacitor, and a second fixed capacitor coupled in parallel with the voltage-variable capacitor.

In some other embodiments, the antenna includes a metasurface having a plurality of radio-frequency (RF) radiating antenna elements. Each of the plurality of antenna elements includes an iris and a tuning circuit coupled across the iris. The tuning circuit includes a varactor, a first Metal-Insulator-Metal (MIM) capacitor coupled in series with the varactor, and a second Metal-Insulator-Metal (MIM) capacitor coupled in parallel with the varactor.

Other aspects and advantages of the embodiments will become apparent from the following detailed description taken in conjunction with the accompanying drawings which illustrate, by way of example, the principles of the described embodiments.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 illustrates an exploded isometric view of a satellite antenna according to some embodiments.

FIG. 2 illustrates a schematic view of a satellite communication system according to some embodiments.

FIG. 3A is an existing configuration of a tuning circuit architecture.

FIG. 3B illustrates some embodiments of a configuration of a tuning circuit architecture.

FIG. 4A is some embodiments of a unit cell of the metasurface antenna.

FIG. 4B illustrates curves that show the equivalent resistance of a tuning circuit disclosed herein.

### DETAILED DESCRIPTION

In the following description, numerous details are set forth to provide a more thorough explanation of embodiments of the present disclosure. It will be apparent, however, to one skilled in the art, that the teachings disclosed herein may be practiced without these specific details. In other instances, well-known structures and devices are shown in block diagram form, rather than in detail, in order to avoid obscuring the present disclosure.

In metasurface antennas, tuning circuits (with, for example, varactor diodes) help create a required pattern over the antenna aperture for radiation at a target angle by changing the voltage across the tuning circuit's terminals (e.g., varactor's terminals). To achieve radio-frequency (RF)-direct current (DC) isolation for radiation elements such as irises, another capacitor (e.g., a Metal-Insulator-Metal (MIM) capacitor) is used in series with the varactor diode (which is a voltage-variable capacitor). This series circuit (i.e., the MIM capacitor and varactor diode) can establish a tuning circuit for a metasurface antenna.

The radiation elements of the metasurface antenna are electrically small, resulting in very small radiation resistance. Unfortunately, the resistance of a varactor diode is not negligible (around 1 Ohm in the Ku band and 2 Ohms in the Ka band) compared to the radiation resistance of the metasurface antenna. Therefore, the resistance of the varactor diode significantly impacts the radiation efficiency of the antenna.

Embodiments of a tuning circuit architecture are disclosed herein. In some embodiments, the tuning circuit controls the resonances of the metasurface antenna. This architecture provides the ability to manipulate the tuning circuit's resistance at the start and end voltage across the varactor diode. The resistance at higher voltages across the varactor diode is more crucial for the efficiency and final performance of the antenna. The tuning circuit architecture disclosed herein allows in the decrease of the equivalent resistance at higher voltages across the varactor diode terminals, albeit at the cost of increased equivalent resistance at lower voltages. Simulations have shown that the performance of the Rx band can be increased by 0.2 dB without changing the antenna's architecture. Thus, while historically, the resistance of the varactor diode has been a bottleneck, causing significant loss and reducing antenna performance, using some embodiments of the tuning circuit disclosed herein mitigates these problems and increases the radiation efficiency of the antenna.

### Examples of Antenna Embodiments

The techniques described herein may be used with a variety of flat panel satellite antennas. Some embodiments of such flat panel antennas are disclosed herein. In some embodiments, the flat panel satellite antennas are part of a satellite terminal. The flat panel antennas include one or more arrays of antenna elements on an antenna aperture.

In some embodiments, the antenna aperture is a metasurface antenna aperture, such as, for example, the antenna apertures described below. In some embodiments, the antenna elements comprise radio-frequency (RF) radiating antenna elements. In some embodiments, the antenna elements include tunable devices to tune the antenna elements. Examples of such tunable devices include diodes and varactors such as, for example, described in U.S. Pat. No. 11,489,266, entitled “Metasurface Antennas Manufactured with Mass Transfer Technologies,” issued Nov. 1, 2022. In some other embodiments, the antenna elements comprise liquid crystal (LC)-based antenna elements, such as, for example, those disclosed in U.S. Pat. No. 9,887,456, entitled “Dynamic Polarization and Coupling Control from a Steerable Cylindrically Fed Holographic Antenna”, issued Feb. 6, 2018, or other RF radiating antenna elements. It should be appreciated that other tunable devices such as, for example, but not limited to, tunable capacitors, tunable capacitance dies, packaged dies, micro-electromechanical systems (MEMS) devices, or other tunable capacitance devices, could be placed into an antenna aperture or elsewhere in variations on the embodiments described herein.

Although embodiments in this disclosure may draw on some examples in communications, some embodiments could be implemented in various receiving, transmitting, and/or sensing or other similar applications. Some examples could include devices for radar, lidar, sensors and sensing device such as, but not limited to, those in autonomous vehicles applications, and any other applications that can take advantage of attributes of an active metasurface according to various disclosed and undisclosed embodiments of the present disclosure.

In some embodiments, the antenna aperture having the one or more arrays of antenna elements is comprised of multiple segments that are coupled together. In some embodiments, when coupled together, the combination of the segments form groups of antenna elements (e.g., closed rings of antenna elements concentric with respect to the antenna feed, etc.). For more information on antenna segments, see U.S. Pat. No. 9,887,455, entitled “Aperture Segmentation of a Cylindrical Feed Antenna”, issued Feb. 6, 2018.

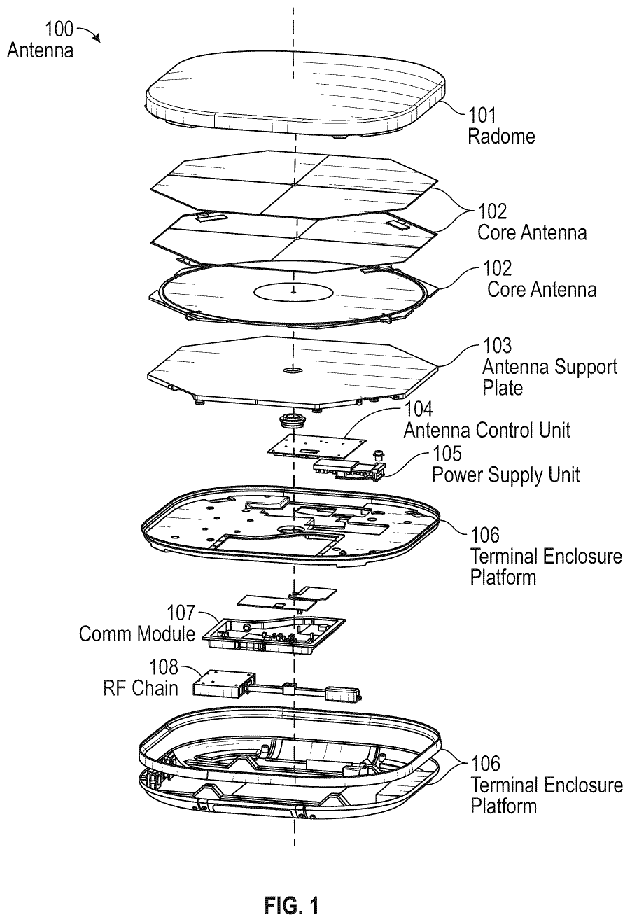

FIG. 1 illustrates an exploded view of some embodiments of a flat-panel antenna. Referring to FIG. 1, antenna 100 comprises a radome 101, a core antenna 102, antenna support plate 103, antenna control unit (ACU) 104, a power supply unit 105, terminal enclosure platform 106, comm (communication) module 107, and RF chain 108.

Radome 101 is the top portion of an enclosure that encloses core antenna 102. In some embodiments, radome 101 is weatherproof and is constructed of material transparent to radio waves to enable beams generated by core antenna 102 to extend to the exterior of radome 101.

In some embodiments, core antenna 102 comprises an aperture having RF radiating antenna elements. These antenna elements act as radiators (or slot radiators). In some embodiments, the antenna elements comprise scattering metamaterial antenna elements. In some embodiments, the antenna elements comprise both Receive (Rx) and Transmit (Tx) irises, or slots, that are interleaved and distributed on the whole surface of the antenna aperture of core antenna 102. Such Rx and Tx irises may be in groups of two or more sets where each set is for a separately and simultaneously controlled band. Examples of such antenna elements with irises are described in U.S. Pat. No. 10,892,553, entitled “Broad Tunable Bandwidth Radial Line Slot Antenna”, issued Jan. 12, 2021.

In some embodiments, the antenna elements comprise irises (iris openings) and the aperture antenna is used to generate a main beam shaped by using excitation from a cylindrical feed wave for radiating the iris openings through tunable elements (e.g., diodes, varactors, patch, etc.). In some embodiments, the antenna elements can be excited to radiate a horizontally or vertically polarized electric field at desired scan angles.

In some embodiments, a tunable element (e.g., diode, varactor, patch etc.) is located over each iris slot. The amount of radiated power from each antenna element is controlled by applying a voltage to the tunable element using a controller in ACU 104. Traces in core antenna 102 to each tunable element are used to provide the voltage to the tunable element. The voltage tunes or detunes the capacitance and thus the resonance frequency of individual elements to effectuate beam forming. The voltage required is dependent on the tunable element in use. Using this property, in some embodiments, the tunable element (e.g., diode, varactor, LC, etc.) integrates an on/off switch for the transmission of energy from a feed wave to the antenna element. When switched on, an antenna element emits an electromagnetic wave like an electrically small dipole antenna. Note that the teachings herein are not limited to having unit cell that operates in a binary fashion with respect to energy transmission. For example, in some embodiments in which varactors are the tunable element, there are 32 tuning levels. As another example, in some embodiments in which LC is the tunable element, there are 16 tuning levels.

A voltage between the tunable element and the slot can be modulated to tune the antenna element (e.g., the tunable resonator/slot). Adjusting the voltage varies the capacitance of a slot (e.g., the tunable resonator/slot). Accordingly, the reactance of a slot (e.g., the tunable resonator/slot) can be varied by changing the capacitance. Resonant frequency of the slot also changes according to the equation

$$f = \frac{1}{2 π \sqrt{LC}}$$

where f is the resonant frequency of the slot and L and C are the inductance and capacitance of the slot, respectively. The resonant frequency of the slot affects the energy coupled from a feed wave propagating through the waveguide to the antenna elements.

In particular, the generation of a focused beam by the metamaterial array of antenna elements can be explained by the phenomenon of constructive and destructive interference, which is well known in the art. Individual electromagnetic waves sum up (constructive interference) if they have the same phase when they meet in free space to create a beam, and waves cancel each other (destructive interference) if they are in opposite phase when they meet in free space. If the slots in core antenna 102 are positioned so that each successive slot is positioned at a different distance from the excitation point of the feed wave, the scattered wave from that antenna element will have a different phase than the scattered wave of the previous slot. In some embodiments, if the slots are spaced one quarter of a wavelength apart, each slot will scatter a wave with a one fourth phase delay from the previous slot. In some embodiments, by controlling which antenna elements are turned on or off (i.e., by changing the pattern of which antenna elements are turned on and which antenna elements are turned off) or which of the multiple tuning levels is used, a different pattern of constructive and destructive interference can be produced, and the antenna can change the direction of its beam(s).

In some embodiments, core antenna 102 includes a coaxial feed that is used to provide a cylindrical wave feed via an input feed, such as, for example, described in U.S. Pat. No. 9,887,456, entitled “Dynamic Polarization and Coupling Control from a Steerable Cylindrically Fed Holographic Antenna”, issued Feb. 6, 2018 or in U.S. Pat. No. 11,489,266, entitled “Metasurface Antennas Manufactured with Mass Transfer Technologies,” issued Nov. 1, 2022. In some embodiments, the cylindrical feed wave feeds core antenna 102 from a central point with an excitation that spreads outward in a cylindrical manner from the feed point. In other words, the cylindrically fed wave is an outward travelling concentric feed wave. Even so, the shape of the cylindrical feed antenna around the cylindrical feed can be circular, square or any shape. In some other embodiments, a cylindrically fed antenna aperture creates an inward travelling feed wave. In such a case, the feed wave most naturally comes from a circular structure.

In some embodiments, the core antenna comprises multiple layers. These layers include the one or more substrate layers forming the RF radiating antenna elements. In some embodiments, these layers may also include impedance matching layers (e.g., a wide-angle impedance matching (WAIM) layer, etc.), one or more spacer layers and/or dielectric layers. Such layers are well-known in the art.

Antenna support plate 103 is coupled to core antenna 102 to provide support for core antenna 102. In some embodiments, antenna support plate 103 includes one or more waveguides and one or more antenna feeds to provide one or more feed waves to core antenna 102 for use by antenna elements of core antenna 102 to generate one or more beams.

ACU 104 is coupled to antenna support plate 103 and provides controls for antenna 100. In some embodiments, these controls include controls for drive electronics for antenna 100 and a matrix drive circuitry to control a switching array interspersed throughout the array of RF radiating antenna elements. In some embodiments, the matrix drive circuitry uses unique addresses to apply voltages onto the tunable elements of the antenna elements to drive each antenna element separately from the other antenna elements. In some embodiments, the drive electronics for ACU 104 comprise commercial off-the shelf LCD controls used in commercial television appliances that adjust the voltage for each antenna element.

More specifically, in some embodiments, ACU 104 supplies an array of voltage signals to the tunable devices of the antenna elements to create a modulation, or control, pattern. The control pattern causes the elements to be tuned to different states. In some embodiments, ACU 104 uses the control pattern to control which antenna elements are turned on or off (or which of the tuning levels is used) and at which phase and amplitude level at the frequency of operation. The elements are selectively detuned for frequency operation by voltage application. In some embodiments, multistate control is used in which various elements are turned on and off to varying levels, further approximating a sinusoidal control pattern, as opposed to a square wave (i.e., a sinusoid gray shade modulation pattern).

In some embodiments, ACU 104 also contains one or more processors executing the software to perform some of the control operations. ACU 104 may control one or more sensors (e.g., a GPS receiver, a three-axis compass, a 3-axis accelerometer, 3-axis gyro, 3-axis magnetometer, etc.) to provide location and orientation information to the processor(s). The location and orientation information may be provided to the processor(s) by other systems in the earth station and/or may not be part of the antenna system.

Antenna 100 also includes a comm (communication) module 107 and an RF chain 108. Comm module 107 includes one or more modems enabling antenna 100 to communicate with various satellites and/or cellular systems, in addition to a router that selects the appropriate network route based on metrics (e.g., quality of service (QoS) metrics, e.g., signal strength, latency, etc.). RF chain 108 converts analog RF signals to digital form. In some embodiments, RF chain 108 comprises electronic components that may include amplifiers, filters, mixers, attenuators, and detectors.

Antenna 100 also includes power supply unit 105 to provide power to various subsystems or parts of antenna 100.

Antenna 100 also includes terminal enclosure platform 106 that forms the enclosure for the bottom of antenna 100. In some embodiments, terminal enclosure platform 106 comprises multiple parts that are coupled to other parts of antenna 100, including radome 101, to enclose core antenna 102.

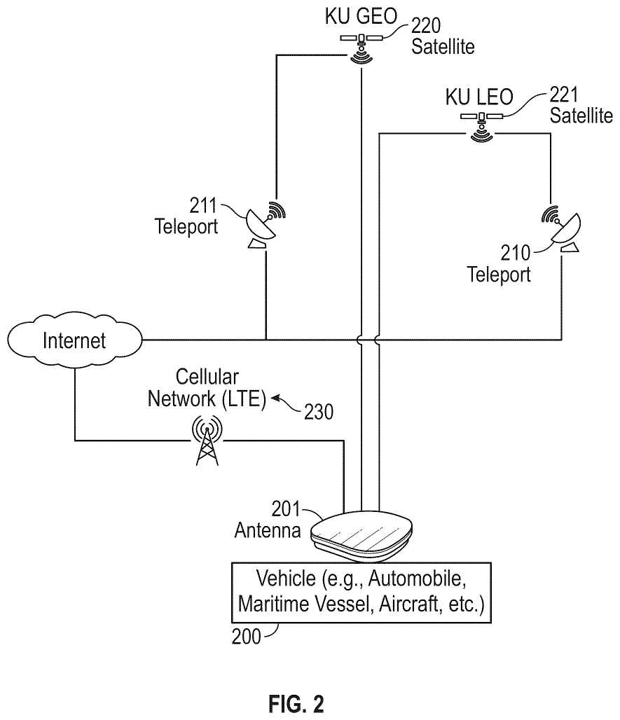

FIG. 2 illustrates an example of a communication system that includes one or more antennas described herein. Referring to FIG. 2, vehicle 200 includes an antenna 201. In some embodiments, antenna 201 comprises antenna 100 of FIG. 1. In some embodiments, vehicle 200 may comprise any one of several vehicles, such as, for example, but not limited to, an automobile (e.g., car, truck, bus, etc.), a maritime vehicle (e.g., boat, ship, etc.), airplanes (e.g., passenger jets, military jets, small craft planes, etc.), etc. Antenna 201 may be used to communicate while vehicle 200 is either on-the-pause or moving. Antenna 201 may be used to communicate to fixed locations as well, e.g., remote industrial sites (mining, oil, and gas) and/or remote renewable energy sites (solar farms, windfarms, etc.).

In some embodiments, antenna 201 is able to communicate with one or more communication infrastructures (e.g., satellite, cellular, networks (e.g., the Internet), etc.). For example, in some embodiments, antenna 201 is able to communication with satellites 220 (e.g., a GEO satellite) and 221 (e.g., a LEO satellite), cellular network 230 (e.g., an LTE network, etc.), as well as network infrastructures (e.g., edge routers, Internet, etc.). For example, in some embodiments, antenna 201 comprises one or more satellite modems (e.g., a GEO modem, a LEO modem, etc.) to enable communication with various satellites such as satellite 220 (e.g., a GEO satellite) and satellite 221 (e.g., a LEO satellite) and one or more cellular modems to communicate with cellular network 230. For another example of an antenna communicating with one or more communication infrastructures, see U.S. Pat. No. 11,818,606, entitled “Multiple Aspects of Communication in a Diverse Communication Network”, and issued Nov. 14, 2023. Communication between a network, such as for example, the Internet and satellites 220 and 221 can be via teleports 211 and 210, respectively.

In some embodiments, to facilitate communication with various satellites, antenna 201 performs dynamic beam steering. In such a case, antenna 201 is able to dynamically change the direction of a beam that it generates to facilitate communication with different satellites. In some embodiments, antenna 201 includes multi-beam beam steering that allows antenna 201 to generate two or more beams at the same time, thereby enabling antenna 201 to communication with more than one satellite at the same time. Such functionality is often used when switching between satellites (e.g., performing a handover). For example, in some embodiments, antenna 201 generates and uses a first beam for communicating with satellite 220 and generates a second beam simultaneously to establish communication with satellite 221. After establishing communication with satellite 221, antenna 201 stops generating the first beam to end communication with satellite 220 while switching over to communicate with satellite 221 using the second beam. For more information on multi-beam communication, see U.S. Pat. No. 11,063,661, entitled “Beam Splitting Hand Off Systems Architecture”, issued Jul. 13, 2021.

In some embodiments, antenna 201 uses path diversity to enable a communication session that is occurring with one communication path (e.g., satellite, cellular, etc.) to continue during and after a handover with another communication path (e.g., a different satellite, a different cellular system, etc.). For example, if antenna 201 is in communication with satellite 220 and switches to satellite 221 by dynamically changing its beam direction, its session with satellite 220 is combined with the session occurring with satellite 221.

In some embodiments, antenna 201 is composed of one or more antennas operating as a single antenna communicating with a single satellite, or multiple antennas operating with multiple satellites simultaneously. For example, antenna 201 could be composed of four antennae in communication with satellite 220, or with two antennae simultaneously in communication with satellite 220 and two antennae in communication with satellite 221.

Thus, the antennas described herein may be part of a satellite terminal that enables ubiquitous communications and multiple different communication connections. In some embodiments, antenna 201 comprises a metasurface RF antenna having multiple RF radiating antenna elements that are tuned to desired frequencies using RF antenna element drive circuitry. The drive circuitry can include a drive transistor (e.g., a thin film transistor (TFT) (e.g., CMOS, NMOS, etc.), low or high temperature polysilicon transistor, memristor, etc.), a Microelectromechanical systems (MEMS) circuit, or other circuit for driving a voltage to an RF radiating antenna element. In some embodiments, the drive circuitry comprises an active-matrix drive. In some embodiments, the frequency of each antenna element is controlled by an applied voltage. In some embodiments, this applied voltage is also stored in each antenna element (pixel circuit) until the next voltage writing cycle.

### Tuning Circuit Embodiments

Embodiments of a tuning circuit are disclosed. In some embodiments, the tuning circuit has a simple structure and creates a trade-off between the values of the varactor's resistance at higher voltage and lower voltage, which can be advantageous because it increases the radiation efficiency of the antenna. That is, some embodiments of a tuning circuit are disclosed herein that offer a trade-off between the equivalent loss resistance of the circuit at high and low bias voltage levels. This can result in higher antenna performance. In some embodiments of an antenna, the loss resistance at higher voltage is more crucial, and by decreasing the resistance at higher voltages (at the cost of increased resistance at lower voltages), the antenna radiation efficiency can be increased. In some embodiments, the tuning circuit can be integrated into many kinds of tunable antennas to optimize radiation performance.

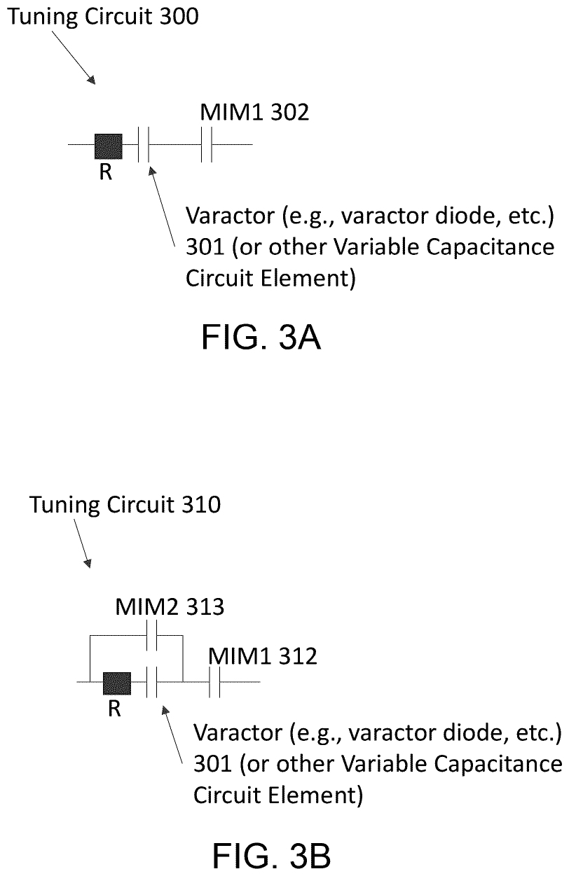

FIG. 3A shows one configuration of the tuning circuit used in a metasurface antenna. Referring to FIG. 3A, the tuning circuit 300 consists of a MIM (metal-insulator-metal) capacitor (fixed capacitance) 302 and a varactor 301 (e.g., varactor diode, etc.) (or other circuit element with a variable capacitance (e.g., a circuit element with a voltage-variable capacitance, etc.)). The resistance R shown in FIG. 3A represents the internal resistance associated with varactor 301. MIM capacitor 302 is used for RF-DC isolation since tuning circuit 300 is placed across the terminals of an iris element (radiating element) of each RF radiating antenna element of the metasurface antenna. Both MIM capacitor 302 and varactor 301 have resistance, but the resistance of varactor 301 is significantly higher than that of MIM capacitor 302. Therefore, for simplicity, the resistance of MIM capacitor 302 is neglected, or ignored.

The varactor is biased from start voltage Vs to end voltage Ve, corresponding to capacitances Cs and Ce for varactor 301, respectively. These two voltages, Vs and Ve, provide the resonances at the start and end frequencies (f₁ and f₂) over the band of interest. In some embodiments, the band of interest is a band from a group consisting of. Ka band, Ku band, X-band (or another band below Ku), Q and V band (or another band above Ka).

FIG. 3B illustrates some embodiments of a tuning circuit that provides the same equivalent capacitance needed to create resonances f₁ and f₂ using the same varactor and voltage range as the tuning circuit in FIG. 3A. Referring to FIG. 3B, tuning circuit 310 has two MIM capacitors 312 and 313. MIM capacitor 312 is coupled (e.g., connected) in series with varactor 301 (e.g., varactor (e.g., varactor diode), voltage-variable capacitance, etc.) and MIM capacitor 313 is coupled (e.g., connected) with varactor 301. Note while varactor 301 can comprise a varactor diode, other voltage-variable capacitance devices, e.g. liquid crystal cells, microelectromechanical systems (MEMS) capacitors, etc., may be used. The resistance R shown in FIG. 3B represents the internal resistance associated with varactor 301.

The parallel MIM2 capacitor 313 in tuning circuit 310 adjusts the resistance of the varactor diode (varactor 301) to different values at higher and lower voltages. Such a feature can be leveraged to increase, and potentially optimize, antenna performance by reducing resistance at higher voltage levels. For example, performance of the receive (Rx) band in some embodiments of the antenna can be increased by 0.2 dB using tuning circuit 310 of FIG. 3B.

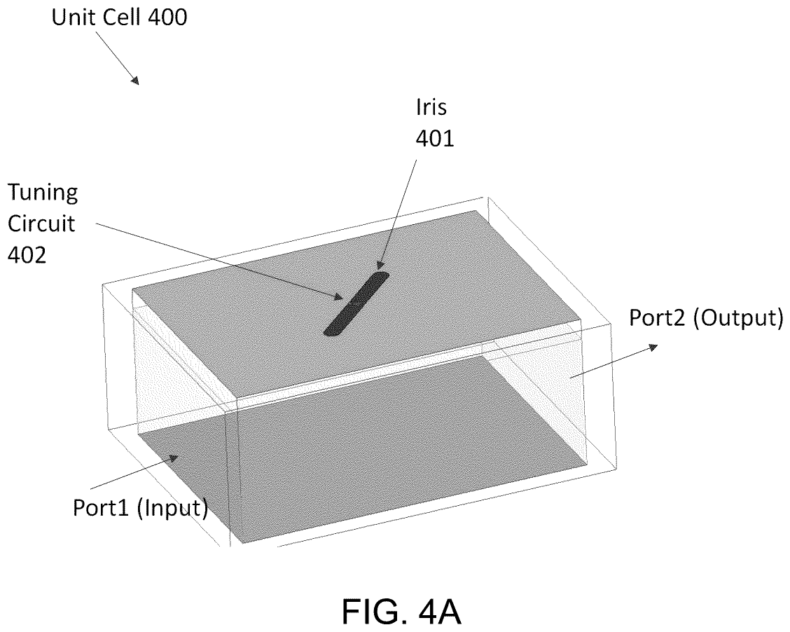

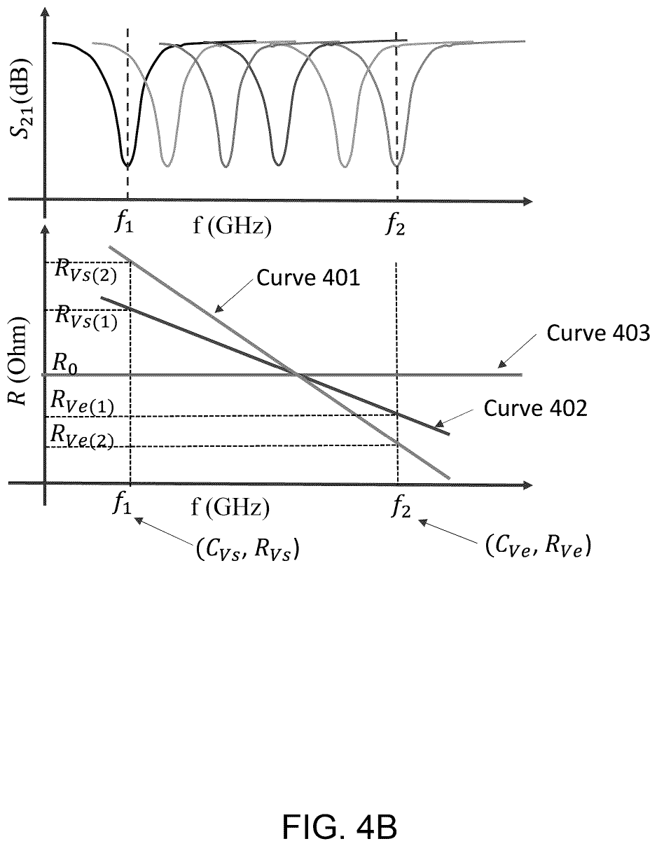

The equivalent resistance of the tuning circuit can be traded at higher and lower frequencies. FIGS. 4A and 4B illustrate this point. For a single unit cell (RF radiating antenna element) 400 in FIG. 4A with iris 401 and a tuning circuit 402 (e.g., the tuning circuit of FIG. 3B) coupled on both of the elongated sides of iris 401 and across the width of iris 401, the resonances are shown in FIG. 4B in the S₂₁ curve. These resonances occur when the bias voltage of tuning circuit 402 is changed. If tuning circuit 300 in FIG. 3A has a constant equivalent resistance of R0 (dominated by the varactor's (varactor 301's) resistance) at all voltage levels, then, at start voltage (Vs) and end voltage (Ve), tuning circuit 300 has equivalent capacitances of C_{Vs} and C_{Ve}, respectively, and an equivalent resistance of R0 at both capacitances at resonance frequencies of f₁ and f₂. The equivalent capacitances of C_{Vs} and C_{Ve} define a tuning range according to the following:

$${C}_{Ve} / {C}_{Vs} = tuning range .$$

With tuning circuit 310 of FIG. 3B, the resistances at start and end frequencies (f₁ and f₂) can be adjusted according to the curves 401 and 402 shown in FIG. 4B (discussed below). In fact, it can be shown that using tuning circuit 310 shown in FIG. 3B, the following trade off can be obtained:

$${R}_{{Vs}^{( 1 )}} \cdot {R}_{{Ve}^{( 1 )}} = {R}_{{Vs}^{( 2 )}} \cdot {R}_{{Ve}^{( 2 )}} = R {0}^{2} .$$

Indices 1 and 2 in the above formula correspond to the two tuning circuit configurations of FIGS. 3A and 3B, respectively, and curves 402 and 401, respectively shown in FIG. 4B. In other words, with tuning circuit 310 of FIG. 3B, resistance at a higher voltage can be traded for resistance at lower voltage at the start and end frequencies while maintaining the same circuit tuning range and resonance frequencies. In many applications, such as with a metasurface antenna, this trade results in higher performance because the equivalent resistance at higher voltage (lower capacitance) is more crucial to antenna performance compared to that at lower voltage. Therefore, use of tuning circuit 310 disclosed herein in a metasurface antenna is preferred.

Referring back to FIG. 4A, unit cell 400 of the metasurface antenna has input power excited at Port 1, radiating partially through the iris 401 (the radiating element), with the remaining power transmitted to Port 2. Tuning circuit 402 can be connected across iris 401 and tunes the required resonance for that specific unit cell 400 using a bias voltage. FIG. 4B illustrates resistance of tuning circuit 310 of FIG. 3B versus frequency. More specifically, the curves at the bottom of FIG. 4B represent how the resistance of the circuit changes as a function of the tuning voltage as the antenna element resonance changes from Vs to Ve (f1 to f2), with those three curves representing three different implementations of the tuning circuit in 3B, demonstrating the trade-off between resistance at Vs and resistance at Ve. For different bias voltages across the varactor (e.g., varactor 301) of tuning circuit 402, iris 401 has different resonances. When a start voltage (nominally 0 volts) is applied to the iris, it resonates at f₁. At higher bias voltages (e.g., 4-20 volts, implying lower capacitance for the varactor diode, the resonance shifts to higher frequencies, and maximum voltage results in resonance at resistance does not change significantly versus the bias voltage. Curves 401 and 402 also show the equivalent resistance of tuning circuit 310 shown in FIG. 4B (with curve 403 representing equivalent resistance of R0 at both capacitances at resonance frequencies of f₁ and f₂).

In some embodiments, the size of MIM1 and MIM2 capacitors ranges from 50 and 500 femtofarads, with the size of MIM2 capacitor being smaller than that of MIM1 capacitor. However, the techniques disclosed herein are not limited to MIM1 and MIM2 capacitors of that size. Note also that MIM capacitors with various types of dielectrics can be used. For example, MIM capacitors with higher dielectric constants can be beneficial to use as they typically have higher capacitance values for a smaller footprint. For example, MIM capacitors with dielectrics such as, for example, but not limited to, silicon nitride (SIN), silicon oxide (SIO), and organic dielectrics, can be used. Also, the two metal layers can be printed circuit board (PCB) metal layers with a dielectric between them. Similarly, a stacked MIM capacitor can be used in which multiple metal layers are interleaved with dielectrics therebetween (e.g., a vertical stack).

Furthermore, while example embodiments disclosed herein include two MIM capacitors, the techniques disclosed herein are not limited to use of MIM capacitors. For example, the capacitors can be interdigitated capacitors manufactured using surface-mount technology (SMT) techniques.

Moreover, while Ka and Ku bands can be associated with the frequency bands and ranges discussed above, the techniques disclosed herein are not limited to such bands and are applicable to other such bands, such as, but not limited to, Q/V band, X band, etc.

There is a number of example embodiments described herein.

Example 1 is antenna including a metasurface having a plurality of radio-frequency (RF) radiating antenna elements. Each of the plurality of antenna elements includes a tuning circuit including a voltage-variable capacitor, a first fixed capacitor coupled in series with the voltage-variable capacitor, and a second fixed capacitor coupled in parallel with the voltage-variable capacitor.

Example 2 is the antenna of example 1 that may optionally include that at least one of the first and second fixed capacitors is a Metal-Insulator-Metal (MIM) capacitor.

Example 3 is the antenna of example 2 that may optionally include that the first and second fixed capacitors are Metal-Insulator-Metal (MIM) capacitors.

Example 4 is the antenna of example 3 that may optionally include that the voltage-variable capacitor includes a varactor.

Example 5 is the antenna of example 1 that may optionally include that the voltage-variable capacitor includes a varactor.

Example 6 is the antenna of example 5 that may optionally include that the varactor includes a varactor diode.

Example 7 is the antenna of example 1 that may optionally include that each of the plurality of antenna elements comprises a radiating element and the tuning circuit is coupled to opposite elongated sides, and across a width, of the radiating element.

Example 8 is the antenna of example 7 that may optionally include that the radiating element comprises an iris.

Example 9 is the antenna of example 8 that may optionally include that for different voltages across the varactor, the iris has different resonances.

Example 10 is the antenna of example 1 that may optionally include that the tuning circuit has equivalent capacitances at two different voltages of end points of a voltage range, the two different voltages corresponding to different resonance frequencies over a frequency band over which the antenna operates.

Example 11 is the antenna of example 10 that may optionally include that the band is a Ka band or Ku band.

Example 12 is an antenna including a metasurface having a plurality of radio-frequency (RF) radiating antenna elements. Each of the plurality of antenna elements includes an iris and a tuning circuit coupled across the iris. The tuning circuit includes a varactor, a first Metal-Insulator-Metal (MIM) capacitor coupled in series with the varactor, and a second Metal-Insulator-Metal (MIM) capacitor coupled in parallel with the varactor.

Example 13 is the antenna of example 12 that may optionally include that for different voltages across the varactor, the iris has different resonances.

Example 14 is the antenna of example 12 that may optionally include that the tuning circuit has equivalent capacitances at two different voltages of end points of a voltage range, the two different voltages corresponding to different resonance frequencies over a frequency band over which the antenna operates.

Example 15 is the antenna of example 14 that may optionally include that the band is a Ka band or Ku band.

Example 16 is the antenna of example 12 that may optionally include that the varactor comprises a varactor diode.

Example 17 is the antenna of example 12 that may optionally include that each of the plurality of antenna elements comprises a radiating element and the tuning circuit is coupled to opposite elongated sides, and across a width, of the radiating element.

Example 18 is the antenna of example 17 that may optionally include that the radiating element comprises an iris.

All of the methods and tasks described herein may be performed and fully automated by a computer system. The computer system may, in some cases, include multiple distinct computers or computing devices (e.g., physical servers, workstations, storage arrays, cloud computing resources, etc.) that communicate and interoperate over a network to perform the described functions. Each such computing device typically includes a processor (or multiple processors) that executes program instructions or modules stored in a memory or other non-transitory computer-readable storage medium or device (e.g., solid state storage devices, disk drives, etc.). The various functions disclosed herein may be embodied in such program instructions, or may be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid-state memory chips or magnetic disks, into a different state. In some embodiments, the computer system may be a cloud-based computing system whose processing resources are shared by multiple distinct business entities or other users.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware (e.g., ASICs or FPGA devices), computer software that runs on computer hardware, or combinations of both. Moreover, the various illustrative logical blocks and modules described in connection with the embodiments disclosed herein can be implemented or performed by a machine, such as a processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the rendering techniques described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements or steps. Thus, such conditional language is not generally intended to imply that features, elements or steps are in any way required for one or more embodiments or that one or more embodiments necessarily include logic for deciding, with or without other input or prompting, whether these features, elements or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, or Z). Thus, such disjunctive language is not generally intended to, and should not, imply that certain embodiments require at least one of X, at least one of Y, and at least one of Z to each be present.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

We claim:

1. An antenna comprising:
a metasurface having a plurality of radio-frequency (RF) radiating antenna elements, wherein each of the plurality of antenna elements includes a tuning circuit comprising
a voltage-variable capacitor,
a first fixed capacitor coupled in series with the voltage-variable capacitor, and
a second fixed capacitor coupled in parallel with the voltage-variable capacitor.

2. The antenna of claim 1 wherein at least one of the first and second fixed capacitors is a Metal-Insulator-Metal (MIM) capacitor.

3. The antenna of claim 2 wherein both of the first and second fixed capacitors are Metal-Insulator-Metal (MIM) capacitors.

4. The antenna of claim 3 wherein the voltage-variable capacitor comprises a varactor.

5. The antenna of claim 1 wherein the voltage-variable capacitor comprises a varactor.

6. The antenna of claim 5 wherein the varactor comprises a varactor diode.

7. The antenna of claim 1 wherein each of the plurality of antenna elements comprises a radiating element and the tuning circuit is coupled to opposite elongated sides, and across a width, of the radiating element.

8. The antenna of claim 7 wherein the radiating element comprises an iris.

9. The antenna of claim 8 wherein for different voltages across the varactor, the iris has different resonances.

10. The antenna of claim 1 wherein the tuning circuit has equivalent capacitances at two different voltages of end points of a voltage range, the two different voltages corresponding to different resonance frequencies over a frequency band over which the antenna operates.

11. The antenna of claim 10 wherein the band is a Ka band or Ku band.

12. An antenna comprising:
a metasurface having a plurality of radio-frequency (RF) radiating antenna elements, wherein each of the plurality of antenna elements includes
an iris; and
a tuning circuit coupled across the iris, the tuning circuit comprising
a varactor,
a first Metal-Insulator-Metal (MIM) capacitor coupled in series with the varactor, and
a second Metal-Insulator-Metal (MIM) capacitor coupled in parallel with the varactor.

13. The antenna of claim 12 wherein for different voltages across the varactor, the iris has different resonances.

14. The antenna of claim 12 wherein the tuning circuit has equivalent capacitances at two different voltages of end points of a voltage range, the two different voltages corresponding to different resonance frequencies over a frequency band over which the antenna operates.

15. The antenna of claim 14 wherein the band is a Ka band or Ku band.

16. The antenna of claim 12 wherein the varactor comprises a varactor diode.

17. The antenna of claim 12 wherein each of the plurality of antenna elements comprises a radiating element and the tuning circuit is coupled to opposite elongated sides, and across a width, of the radiating element.

18. The antenna of claim 17 wherein the radiating element comprises an iris.
